(19) United States
(12) Patent Application Publication
(10) Pub. No.: US 2014/0055484 A1
(43) Pub. Date: Feb. 27, 2014

(54) ELECTRONIC DEVICE DISPLAYING AN IMAGE BY USING IMAGE INCLUDED IN CONTENT AND A METHOD OF DISPLAYING THE IMAGE ON THE ELECTRONIC DEVICE

(71) Applicant: SAMSUNG ELECTRONICS CO., LTD., Suwon-si (KR)

(72) Inventors: Min-jeong MOON, Seoul (KR); Se-jun PARK, Seoul (KR); Woo-yong CHANG, Yongin-si (KR); Chul-ho HAN, Seoul (KR)

(73) Assignee: SAMSUNG ELECTRONICS CO., LTD., Suwon-si (KR)

(21) Appl. No.: 13/975,804

(22) Filed: Aug. 26, 2013

(30) Foreign Application Priority Data
Aug. 24, 2012 (KR) 10-2012-0093302

(51) Int. Cl. G06T 11/00

(52) U.S. Cl. CPC G06T 11/001
USPC 345/593

(57) ABSTRACT

A method of displaying an image by using an image included in a content, and an electronic device using the same are provided. The method includes acquiring an image included in a content, dividing the acquired image into a plurality of regions, acquiring color information related to the plurality of divided regions, and generating a color palette based on the acquired color information. The electronic device provides an image acquirer that is configured to acquire an image included in content; a regions setter configured to divide into a plurality of regions the image acquired by the image acquirer; a color extractor configured to extract color information related to the plurality of divided regions; and a color palette generator configured to generate a color palette based on the color information acquired by the color extractor, wherein the color palette is used to determine a color of the image displayed on the electronic device.

### CROSS-REFERENCE TO RELATED PATENT APPLICATION

This application claims the benefit of Korean Patent Application No. 10-2012-0093302, filed on Aug. 24, 2012, in the Korean Intellectual Property Office, the disclosure of which is incorporated herein in by reference, in its entirety.

### BACKGROUND

1. Field

The exemplary embodiments relate to methods of displaying an image according to content and electronic devices using the same. More particularly, the exemplary embodiments relate to methods of displaying an image by generating a color palette from an image included in content, and electronic devices using the method of displaying an image.

2. Description of the Related Art

In order for an electronic device to display a new image as a background image in the Related Arts, a user should manually search for and select an image to be displayed as the background image.

Even in a case where an image displayed on an electronic device is updated by the electronic device, since the displayed image only changes with time, an image to be displayed on the electronic device may only be determined by predetermined information. A personalized image personalized according to each user may not be displayed.

### SUMMARY

Exemplary embodiments provide methods of displaying an image by using an image included in content, and electronic devices using the same.

Exemplary embodiments also provide methods of generating or changing an image by using an image included in content reproduced or generated in an electronic device, and displaying the generated or changed image, and electronic devices using the same.

According to an aspect of an exemplary embodiment, there is provided a method of displaying an image on an electronic device, including: acquiring an image included in content; dividing the acquired image into a plurality of regions; acquiring color information related to the plurality of divided regions; and generating a color palette based on the acquired color information, wherein the color palette is used to determine a color of the image displayed in the electronic device.

The acquiring of the color information may include acquiring an average color of pixels included in the divided region.

The acquiring of the color information may include: acquiring an average color of colors of pixels included in the divided region; and determining any one of colors included in a predetermined color composition table based on a similarity between the average color and a color included in the predetermined color composition table.

The content may be a plurality of contents, and the generating of the color palette may include: storing the number of times each color information has been acquired from images included in the plurality of contents.

The content may be a content which is reproduced or generated in the electronic device.

The method may further include generating a database storage information related to the reproduced or generated content according to a point in time when the content is reproduced or generated in the electronic device, wherein the acquiring of the image included in the content may include: selecting the content from the database according to the point in time when the content is reproduced or generated in the electronic device; and acquiring the image included in the selected content.

The method may further include: selecting an image to be displayed from among images stored in the electronic device based on brightness, chroma, and color of the color information included in the color palette; and changing a color of the selected image by using the generated color palette.

The respective operations may be repeated at predetermined periods of time.

The image included in the content may be a thumbnail image included in metadata of the content.

According to another aspect of an exemplary embodiment, there is provided a non-transitory computer-readable storage medium that stores a program for executing the above method for image display.

According to another aspect of an exemplary embodiment, there is provided an electronic device having a display device, including: an image acquirer configured to acquire an image included in content; region setter configured to divide into a plurality of regions the image acquired by the image acquirer; a color extractor configured to extract color information related to the plurality of divided regions; and a color palette generator configured to generate a color palette based on the color information acquired by the color extractor, wherein the color palette is used to determine a color of the image displayed in the electronic device.

The color extractor may acquire an average color of pixels included in the divided region.

The color extractor may acquire any one of colors included in a predetermined color composition table based on a similarity between an average color of pixels included in the divided region and a color included in the predetermined color composition table.

The content may be a plurality of contents, and the color palette generator may include: a counter configured to store a number of times each color information has been acquired from images included in the plurality of contents; and a color determiner configured to determine a color to be included in the color palette, based on the number of times the color information has been acquired.

The content may be reproduced or generated in the electronic device.

The electronic device may further include a database storage configured to store information related to the content reproduced or generated in the electronic device according to a point in time when the content is reproduced or generated in the electronic device, wherein the image acquirer may be configured to select the content from the database storage according to the point in time when the content is reproduced or generated in the electronic device, and may acquire the image included in the selected content.

The electronic device may further include an image generator configured to select an image to be displayed among images stored in the electronic device, based on brightness, chroma, and color of the color information included in the color palette, and changes a color of the selected image by using the color palette generated by color palette generator.

The color palette may be generated repeatedly at predetermined periods of time.

The image included in the content may be a thumbnail image included in metadata of the content.

An aspect of an exemplary embodiment may provide an electronic device including: a regions setter configured to divide an acquired image into a plurality of regions; a color extractor configured to extract color information related to the plurality of divided regions; and a color palette generator configured to generate a color palette based on the color information acquired by the color extractor, wherein the color palette is used to determine a color of the image.

The electronic device may further include a display and may further include an image acquirer that is configured to acquire an image included in content.

The color extractor may acquire an average color of pixels included in the divided region.

The color extractor may be configured to acquire any one of colors included in a predetermined color composition table based on a similarity between an average color of pixels included in the divided region and a color included in the predetermined color composition table.

The content may be a plurality of contents, and the color palette generator may include: a counter configured to store a number of times each color information has been acquired from images included in the plurality of contents.

The color palette generator may further comprise a color determiner configured to determine a color to be included in the color palette based on the number of times the color information has been acquired. In addition, the content may be reproduced or generated in the electronic device.

The electronic device may further include a database storage configured to store information related to the content reproduced or generated in the electronic device according to a point of time when the content is reproduced or generated in the electronic device.

The image acquirer may be configured to select the content from the database storage according to the point of time when the content is reproduced or generated in the electronic device, and acquires the image included in the selected content.

The electronic device may further include an image generator configured to select an image to be displayed from among images stored in the electronic device based on brightness, chroma and color of the color information included in the color palette, and changes a color of the selected image by using the color palette generated by color palette generator.

### BRIEF DESCRIPTION OF THE DRAWINGS

The above and other features and advantages become more apparent by describing in detail the exemplary embodiments thereof with reference to the attached drawings in which:

FIG. 1 is a flowchart which illustrates a process of generating a color palette and displaying an image, according to an exemplary embodiment;

FIG. 2 is a flowchart which illustrates a process of acquiring color information of a divided region, according to an exemplary embodiment;

FIG. 3 is a flowchart which illustrates a process of acquiring an image included in content, according to an exemplary embodiment;

FIG. 4 is a block diagram which illustrates a schematic configuration of an electronic device according to an exemplary embodiment;

FIG. 5 is a diagram which illustrates an example of dividing regions from an image included in content and acquiring color information, according to an exemplary embodiment;

FIG. 6 is a diagram which illustrates an example of an image divided into a plurality of regions and an example of a color palette generated from an image, according to an exemplary embodiment;

FIG. 7 is a diagram which illustrates an example of generating a color palette by using a color composition table, according to an exemplary embodiment; and

FIG. 8 is a diagram which illustrates an example of changing an image by using a generated color palette, according to an exemplary embodiment.

### DETAILED DESCRIPTION OF EXEMPLARY EMBODIMENTS

Exemplary embodiments will be described below in detail with reference to the accompanying drawings so that those skilled in the art may easily implement the exemplary embodiments. The invention may, however, be embodied in many different forms and should not be construed as being limited to the exemplary embodiments set forth herein. In addition, portions irrelevant to the description of the exemplary embodiments will be omitted in the drawings to provide a clear description, and like reference numerals will denote like elements throughout the specification.

It will be understood that when an element is referred to as being “connected” to another element, it may be directly connected to the other element or may be indirectly connected to the other element with other element(s) interposed there between. It will also be understood that the terms “comprises,” “includes,” and “has,” when used herein, specify the presence of stated elements, but do not preclude the presence or addition of other elements, unless otherwise defined.

Hereinafter, exemplary embodiments will be described in detail with reference to the accompanying drawings.

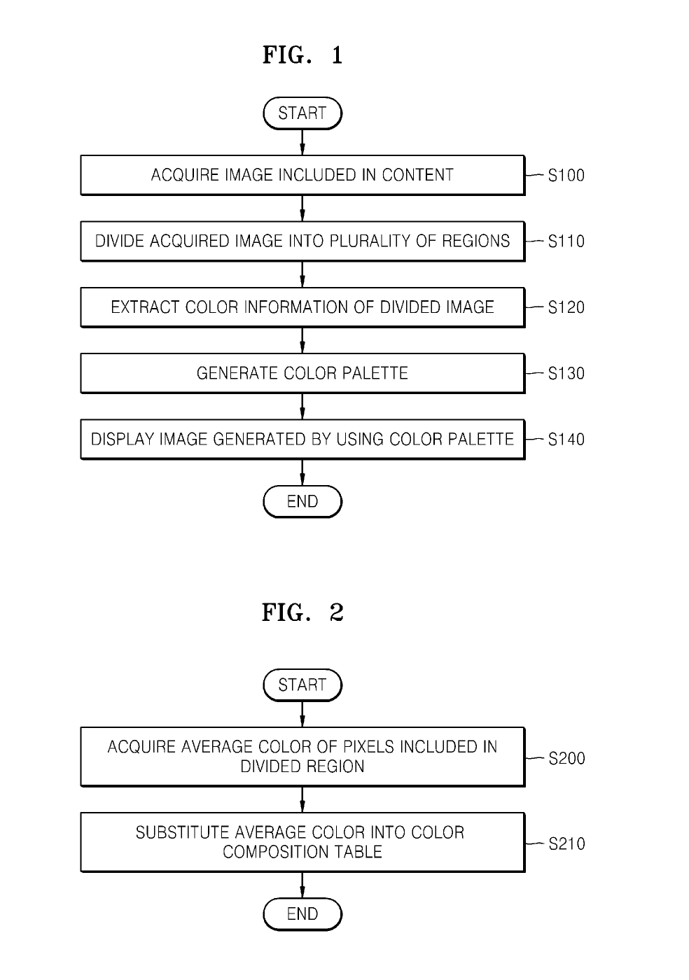

FIG. 1 is a flowchart which illustrates a process of generating a color palette and displaying an image, according to an exemplary embodiment.

An electronic device 400 may acquire an image included in content (S100). The electronic device 400 may be any device capable of displaying an image, such as a portable terminal, a tablet personal computer (PC), and a PC having a display device.

The content may include moving images, pictures, or sound sources. According to an exemplary embodiment, the content may be reproduced by or generated in the electronic device 400. For example, the content may include music files reproduced by the electronic device 400, or may include pictures taken by a camera of the electronic device 400.

According to an exemplary embodiment, the image included in the content may be the content itself or an image included in the metadata of the content. For example, when the content is a picture, the image included in the content may be the picture itself. As another example, when the content is a music file, the image included in the content may be an album jacket image included in the metadata of the music file. As another example, when the content is a moving image, the image included in the content may be a thumbnail image included in the metadata of the moving image.

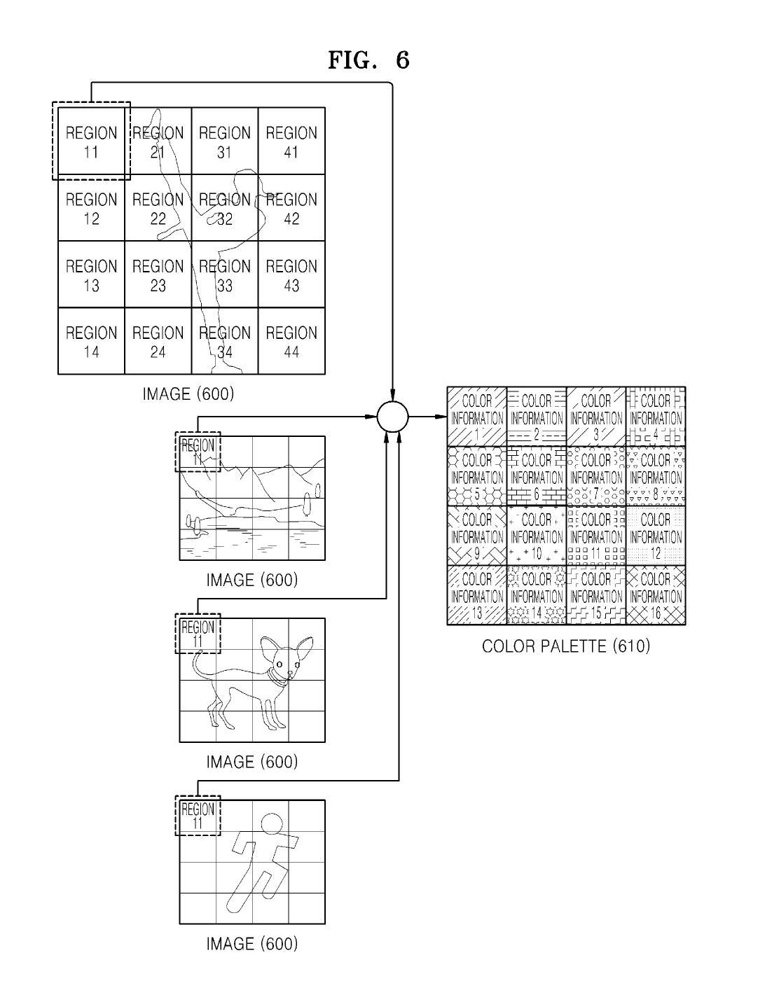

Thereafter, the electronic device 400 may divide the acquired image into a plurality or regions (S110). According to an exemplary embodiment, the number of divided regions may be determined according to the number of pieces of color information included in a color palette 610. For example, as illustrated in FIG. 6, when the color palette 610 includes 16 colors, an acquired image 600 may be may be divided into 4 regions in a horizontal direction and into 4 regions in a vertical direction.

The color palette 610 may be a set of color information used to generate an image. The electronic device 400 may display an image generated by using color information included in the color palette 610.

Thereafter, the electronic device 400 may acquire color information related to the divided region (S120). According to an exemplary embodiment, the electronic device 400 may acquire an average color of pixels included in the divided region. The average color may be acquired by calculating a distribution of all colors by red/green/blue (RGB) values of the pixels included in the divided region and selecting a representative color.

According to an exemplary embodiment, the electronic device 400 may acquire color information of a pixel at a predetermined position among pixels included in the divided region. For example, the electronic device 400 may acquire information related to a color of the pixel located at the center of the divided region.

However, a method of acquiring the color information representing the color of the divided region is not limited thereto, and the color information may also be acquired through various methods.

Thereafter, the electronic device 400 may be configured to generate a color palette 610 based on the acquired color information (S130). For example, when a violet color, a red color and a black color are obtained from each region in operation S120, the electronic device 400 may generate a color palette including information related to each color.

According to an exemplary embodiment, the color palette 610 may have the shape of a matrix in which each element includes color information.

According to an embodiment of the present invention, as illustrated in FIG. 6, when a plurality of images 600 are divided into a plurality of regions, the electronic device 400 may acquire color information from a region 11 included in the plurality of images 600. Among the acquired color information, the electronic device 400 may determine color information that has been acquired the greatest number of times. The electronic device 400 may generate a color palette 610 including color information that has been acquired the greatest number of times.

For example, when a violet color is acquired from the region 11 of three images 600 and a red color is acquired from the region 11 of one image 600, color information 1 of the color palette 610 illustrated in FIG. 6 may be color information representing a violet color. Likewise, the electronic device 400 may determine color information of color information 2 to 16 included in the color palette 610.

Thereafter, the electronic device 400 may change or generate an image by using the generated color palette, and may display the generated image on a display 480 of the electronic device 400 (S140).

According to an exemplary embodiment, when generating an image such as a background image included in a graphic user interface (GUI), the electronic device 400 may generate an image by using the color information included in the color palette. The electronic device 400 may generate an image reflecting the color information of the image included in the content by changing the color palette of a previous image into the color palette 610 generated in operation S130.

Thereafter, according to an exemplary embodiment, the electronic device 400 may repeatedly perform the above respective operations at predetermined periods. For example, when the period is set to 24 hours, the electronic device 400 may regenerate an image every 24 hours, and may display the regenerated image on display 480.

FIG. 2 is a flowchart which illustrates a process of acquiring color information of a divided region, according to an exemplary embodiment.

The electronic device 400 may acquire an average color of the pixels included in the region divided in operation S110 (S200). The average color may be acquired by calculating a distribution of all colors by RGB values of the pixels included in the divided region and selecting a representative color.

The electronic device 400 may substitute the acquired average color into a color composition table 710 (S210). For example, when the color information acquired from the region 11 of the image 600 illustrated in FIG. 6 is most similar to color information related to a red color from among the color information included in the color composition table 710, the electronic device 400 may acquire color information related to a red color from the region 11 of the image 600.

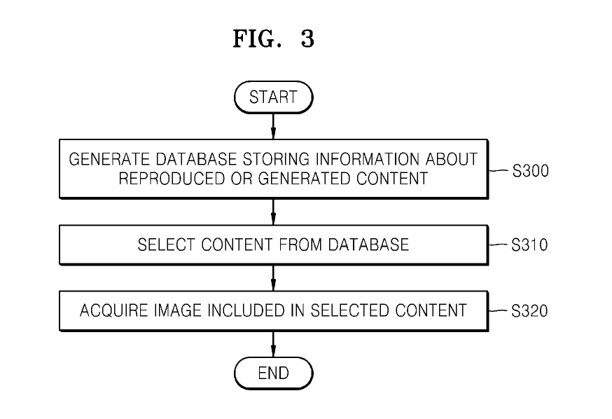

FIG. 3 is a flowchart which illustrates a process of acquiring an image included in content, according to an exemplary embodiment.

First, an electronic device 400 may generate a database that stores information related to the reproduced or generated content (S300). The database may be stored according to a point of time when the content is reproduced or generated in the electronic device 400. For example, when a moving image is reproduced in the electronic device 400, metadata of the reproduced moving image and information related to the point of time when the moving image is reproduced in the electronic device 400 may be stored in the database. The database may be stored in a separate server or in a database storage 460 of the electronic device 400.

Thereafter, the electronic device 400 may select content from the database (S300). For example, according to information preset in the electronic device 400, the electronic device 400 may select content that has been reproduced or generated in the electronic device 400 from 12 hours before the current time until the current time.

Thereafter, the electronic device 400 may acquire the image 600 included in the selected content (S320).

According to an exemplary embodiment, the image 600 may be acquired from the metadata of the content stored in the database.

According to another exemplary embodiment, the image 600 may be acquired from a server in which the selected content is located. For example, when the electronic device 400 reproduces a sound source file through a streaming service, and the electronic device 400 may receive an album jacket image related to a source from a server storing the sound source file.

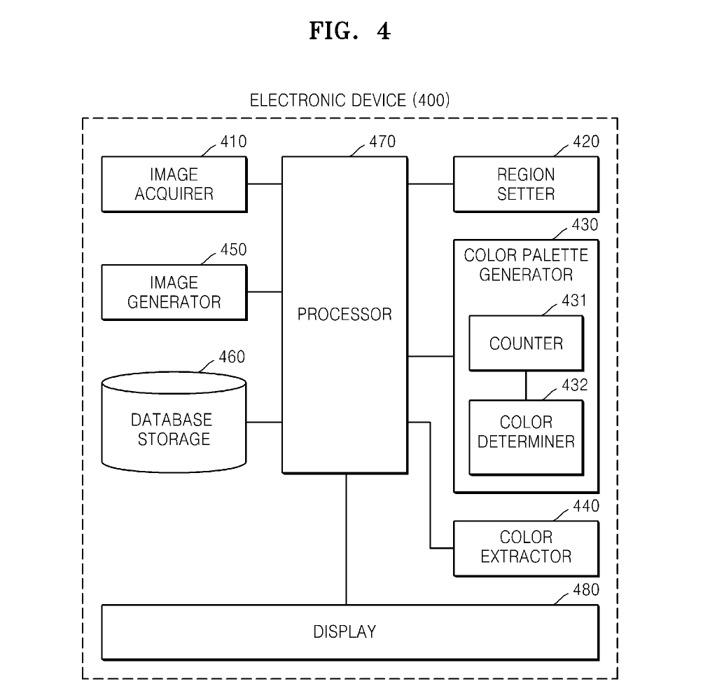

FIG. 4 is a block diagram illustrating a schematic configuration of an electronic device according to an exemplary embodiment.

The electronic device 400 according to an exemplary embodiment may include an image acquirer 410 that is configured to acquire an image included in content, a region setter 420 that is configured to divide the image acquired by the image acquiring unit 410 into a plurality of regions, a color extractor 440 that is configured to acquire color information from the plurality of regions set by the region setter 420, a color palette generator 430 that generates a color palette 610 including the color information acquired by the color extractor 440, an image generator 450 that is configured to change or generate an image by using the color palette 610 generated by the color palette generator 430, a database storage 460 that is configured to store information related to store the content, a display 480 that is configured to display the image generated by the image generator 450, and an information processor 470 that is configured to control the respective devices.

According to an exemplary embodiment, the image acquirer 410 may acquire the content itself or may acquire an image included in metadata of the content.

According to another exemplary embodiment, the image acquirer 410 may select content from the database storage 460 according to a point in time when the content has been reproduced in the electronic device 400, and may acquire an image included in the selected content.

According to an exemplary embodiment, the region setter 420 may divide the image 600 acquired by the image acquirer 410 into a plurality of regions. For example, as illustrated in FIG. 6, when the region setter 420 is set such that an image is divided into four regions in a horizontal direction and into four regions in a vertical direction, the image 600 may be may be divided into a total of 16 regions.

According to an exemplary embodiment, the color extractor 440 may acquire an average color of pixels included in the region divided by the region setter 420.

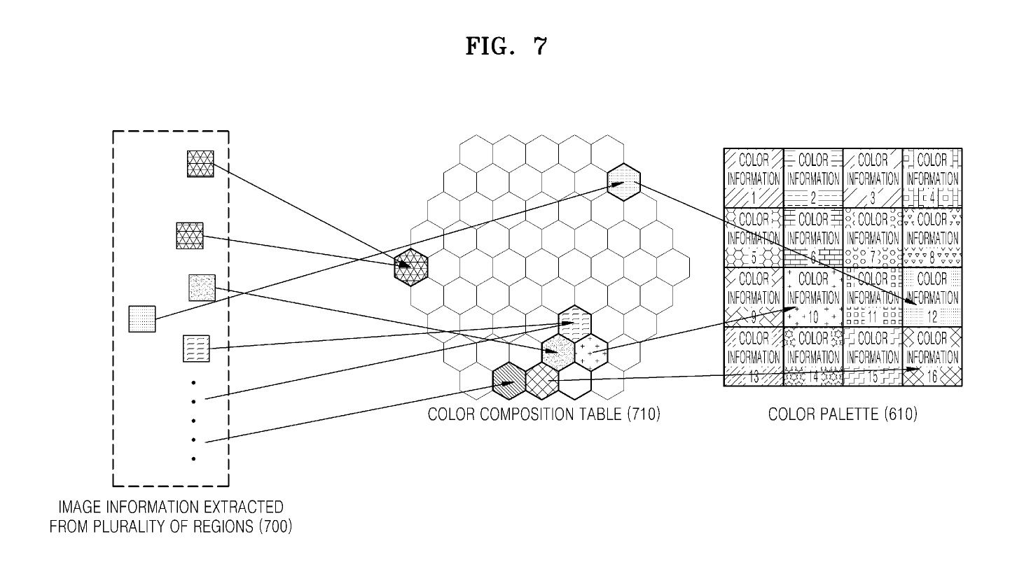

According to another exemplary embodiment, the color extractor 440 may acquire color information that is most similar to the average color from among the colors included in a predetermined color composition table 710, based on a similarity between the average color of pixels included in the divided region and the color included in the predetermined color composition table 710, as illustrated in FIG. 7.

According to an exemplary embodiment, the color palette generator 430 may generate a color palette 610 which includes the color information acquired by the color extractor 440.

According to another exemplary embodiment, the color palette generator 430 may include a counter 431 that is configured to select color information that has been acquired the greatest number of times in each region, from among the color information acquired by the color extractor 440 from a plurality of contents, and a color determiner 432 that is configured to generate a color palette 610 which includes the color information determined by the counter 431.

The image generator 450 may be configured to generate or change an image generated by using the color palette 610 generated by the color palette generator 430.

According to an exemplary embodiment, the image generator 450 may be configured to select an image to be displayed from among the images stored in the electronic device 400 based on brightness, chroma, and color of the color information included in the color palette 610 generated by the color palette generator 430. For example, the image generator 450 may select an image that is most similar to the brightness, chroma, and color of the color information included in the color palette 610 and the brightness, chroma, and color of the image stored in the electronic device 400.

According to an exemplary embodiment, the image generator 450 may change the image selected from the images stored in the electronic device 400, by using the color palette 610 generated by the color palette generator 430. That is, by using the color information included in the color palette 610 generated by the color palette generator 430, the image generator 450 may change the color of the selected image into the color included in the color palette 610.

According to an exemplary embodiment, the database storage 460 may be configured to store information related to content reproduced or executed according to a point of time when the content is reproduced or generated in the electronic device 400. The information related to the content reproduced or executed may include metadata of the content or may include the content itself. Also, the information related to the content reproduced or executed may include information related to the point of time when the content is reproduced or executed.

The display 480 may perform a display operation through, for example, a liquid crystal display (LCD) panel or through a light emitting diode (LED) panel. According to an exemplary embodiment, the display 480 may display the image generated by the image generator 450.

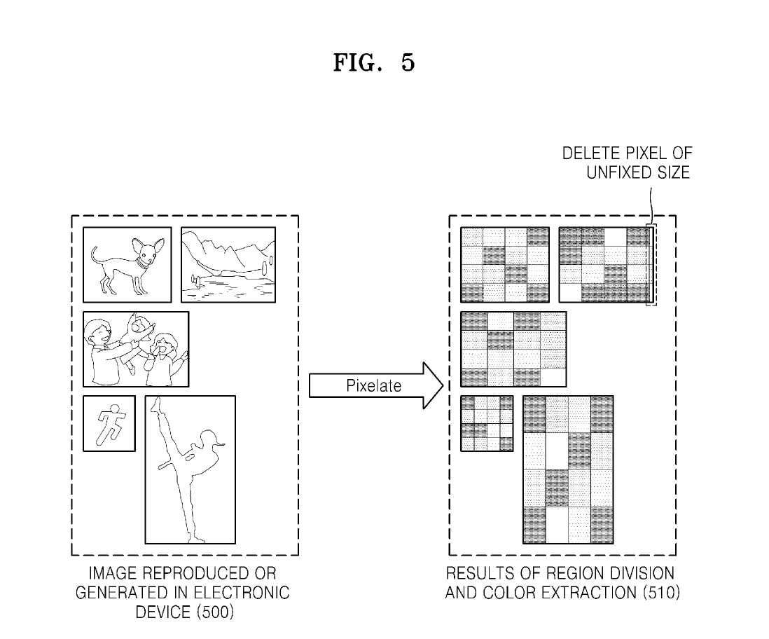

FIG. 5 is a diagram which illustrates an example of dividing regions from an image included in content and acquiring color information, according to an exemplary embodiment.

According to an exemplary embodiment, the electronic device 400 may acquire an image related to the content reproduced or generated in the electronic device 400. In order to reduce the number of pieces of color information included in the image by the number of pieces of color information to be included in the color palette 610, the electronic device 400 may divide a region of the acquired image and may acquire color information of each of the divided regions. The electronic device 400 may delete information included in the pixel that is not included in a predetermined number of regions.

FIG. 6 is a diagram which illustrates an example of an image divided into a plurality of regions and an example of a color palette generated from an image, according to an exemplary embodiment.

According to an exemplary embodiment, the electronic device 400 may divide into a plurality of regions the image 600 included in the content. The electronic device 400 may acquire color information from each of the divided regions and may generate a color palette 610 based on the acquired color information. For example, the electronic device 400 may generate a color palette 610 including color information 1 acquired from a region 11 in order to color information 16 acquired from a region 44.

According to an exemplary embodiment, when the image 600 is plural, the electronic device 400 may divide the plurality of images into 16 regions. The electronic device 400 may acquire color information from the region 11 of each image and may determine color information that has been acquired the greatest number of times. The electronic device 400 may determine the color information, which has been acquired the greatest number of times from the region 11 of each image, as the color information 1 of the color palette 610. In this manner, the electronic device 400 may determine each color information included in the color palette 610.

FIG. 7 is a diagram which illustrates an example of generating a color palette by using a color composition table, according to an exemplary embodiment.

According to an exemplary embodiment, the electronic device 400 may compare color information 700 acquired from a plurality of regions of the image included in the content with the color information included in the color composition table 710, and may determine the color information that is most similar to the acquired color information 700 from among the color information included in the color composition table 710. The electronic device 400 may generate a color palette 610 including the color information determined among the color information included in the color composition table 710.

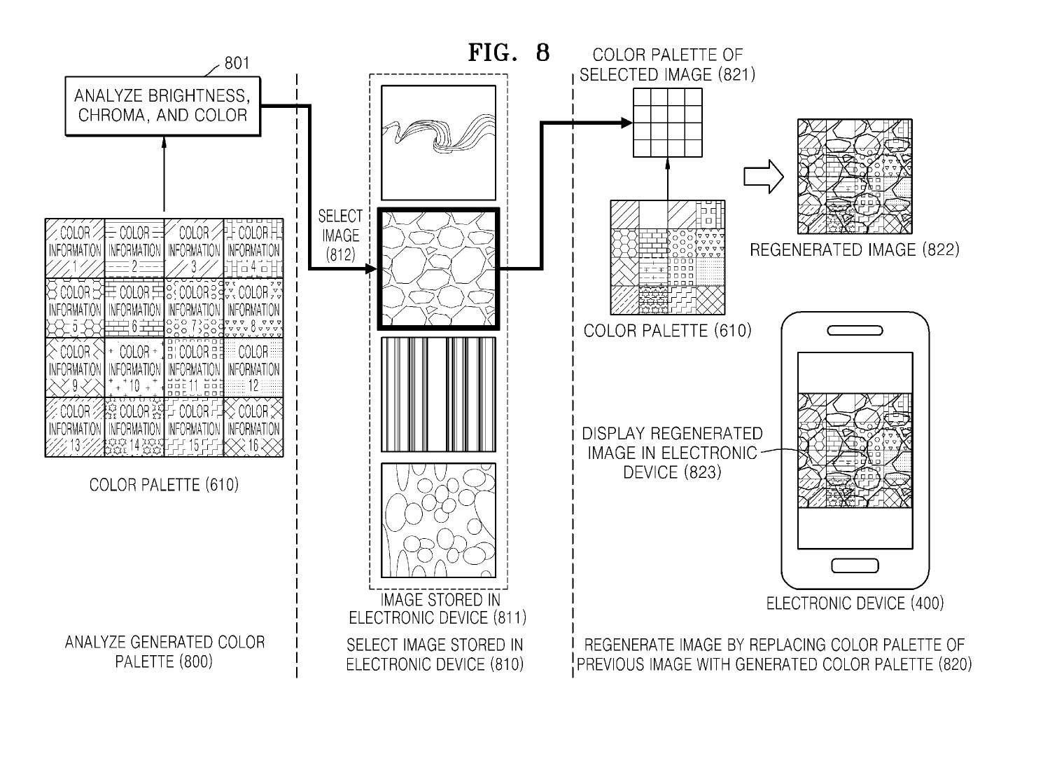

FIG. 8 is a diagram which illustrates an example of changing an image by using a generated color palette, according to an exemplary embodiment.

First, the electronic device 400 may analyze the color palette 610 generated from the image included in the content (800).

According to an exemplary embodiment, the electronic device 400 may analyze the brightness, chroma and color of the color palette 610 (801).

According to the analysis results on the color palette 610, the electronic device 400 may thereafter select an image having brightness, chroma, and color that are most similar to the brightness, chroma, and color of the color palette 610 among an image 811 stored in the electronic device 400 (810).

Thereafter, the electronic device 400 may replace a color palette 821 of a selected image 812 with the generated color palette 610 in order to regenerate (822) an image (820). The electronic device 400 may display the regenerated image on a screen of the electronic device 400 (823). Herein, regenerating the image (822) may mean changing the image.

The exemplary embodiments may also be implemented in the form of a non-transitory computer-readable recording medium which include instructions executable by a computer, such as a program module executed by a computer. The non-transitory computer-readable recording medium may be any available medium accessible by computers, examples of which may include a volatile recording medium, a nonvolatile recording medium, a removable recording medium, and an unremovable recording medium. Examples of the computer-readable medium may also include a computer storage medium and a communication medium. Examples of the computer storage medium may include a volatile storage medium, a nonvolatile storage medium, a removable storage medium, and an unremovable storage medium that are implemented by any method or technology in order to store information such as computer-readable instructions, data structures, program modules, or other data. Examples of the communication medium may include any information transmission medium including computer-readable instructions, data structures, program modules, other data of modulated data signals such as carrier waves, or other transmission mechanisms.

The foregoing is illustrative of exemplary embodiments and is not to be construed as limiting thereof. Although the exemplary embodiments have been described above, those skilled in the art will readily appreciate that various modifications are possible in the exemplary embodiments without materially departing from the novel teachings and advantages of the exemplary embodiments. Therefore, it is to be understood that the exemplary embodiment described above should be considered in descriptive sense only and not for purposes of limitation. For example, the components described as being combined may also be implemented in a distributed manner, and the components described as being distributed may also be implemented in a combined manner.

Therefore, the scope of the invention is defined not by the detailed description of the invention but by the appended claims, and all modifications or differences within the scope should be construed as being included in the present invention.

What is claimed is:

1. A method of displaying an image on an electronic device, comprising:
acquiring an image included in content;
dividing the acquired image into a plurality of regions;
acquiring color information related to the plurality of divided regions; and
generating a color palette based on the acquired color information,
wherein the color palette is used to determine a color of the image displayed on the electronic device.

2. The method of claim 1, wherein the acquiring of the color information comprises acquiring an average color of pixels included in the divided region.

3. The method of claim 1, wherein the acquiring of the color information comprises:
acquiring an average color of pixels included in the divided region; and
determining any one of the colors included in a predetermined color composition table based on a similarity between the average color and a color included in the predetermined color composition table.

4. The method of claim 1, wherein the content is a plurality of contents, and the generating of the color palette comprises:
storing a number of times each color information that has been acquired from images included in the plurality of contents; and
determining a color to be included in the color palette, based on the number of times the color information has been acquired.

5. The method of claim 1, wherein the content is a content which is reproduced or generated in the electronic device.

6. The method of claim 5, further comprising generating a database storing information related to the reproduced or generated content according to a point of time when the content is reproduced or generated in the electronic device,
wherein the acquiring of the image included in the content comprises:
selecting the content from the database according to the point of time when the content is reproduced or generated in the electronic device; and
acquiring the image included in the selected content.

7. The method of claim 1, further comprising:
selecting an image to be displayed from among images stored in the electronic device based on brightness, chroma, and color of the color information included in the color palette; and
changing a color of the selected image by using the generated color palette.

8. The method of claim 1, wherein the respective operations are repeated at predetermined periods of time.

9. The method of claim 1, wherein the image included in the content is a thumbnail image included in metadata of the content.

10. An electronic device having a display device, comprising:
an image acquirer that is configured to acquire an image included in content;
a regions setter configured to divide into a plurality of regions the image acquired by the image acquirer;
a color extractor configured to extract color information related to the plurality of divided regions; and
a color palette generator configured to generate a color palette based on the color information acquired by the color extractor,
wherein the color palette is used to determine a color of the image displayed on the electronic device.

11. The electronic device of claim 10, wherein the color extractor acquires an average color of pixels included in the divided region.

12. The electronic device of claim 10, wherein the color extractor is configured to acquire any one of colors included in a predetermined color composition table based on a similarity between an average color of pixels included in the divided region and a color included in the predetermined color composition table.

13. The electronic device of claim 10, wherein the content is a plurality of contents, and the color palette generator comprises:
a counter configured to store a number of times each color information has been acquired from images included in the plurality of contents; and
a color determiner configured to determine a color to be included in the color palette based on the number of times the color information has been acquired.

14. The electronic device of claim 10, wherein the content is reproduced or generated in the electronic device.

15. The electronic device of claim 14, further comprising a database storage configured to store information related to the content reproduced or generated in the electronic device according to a point of time when the content is reproduced or generated in the electronic device,
wherein the image acquirer is configured to select the content from the database storage according to the point of time when the content is reproduced or generated in the electronic device, and acquires the image included in the selected content.

16. The electronic device of claim 10, further comprising an image generator configured to select an image to be displayed from among images stored in the electronic device based on brightness, chroma, and color of the color information included in the color palette, and changes a color of the selected image by using the color palette generated by color palette generator.

17. The electronic device of claim 10, wherein the color palette is repeatedly generated at predetermined periods of time.

18. The electronic device of claim 10, wherein the image included in the content is a thumbnail image included in metadata of the content.

19. A non-transitory computer-readable recording medium that stores a program, wherein the program, when executed by a processor of a computer, causes the computer to execute the method of claim 1.

20. An electronic device comprising:
a regions setter configured to divide an acquired image into a plurality of regions;
a color extractor configured to extract color information related to the plurality of divided regions; and
a color palette generator configured to generate a color palette based on the color information acquired by the color extractor,
wherein the color palette is used to determine a color of the image.

21. The electronic device of claim 20, further comprising a display.

22. The electronic device of claim 20, further comprising an image acquirer that is configured to acquire an image included in content.

23. The electronic device of claim 22, wherein the image configured to be divided by the regions setter is acquired by the image acquirer.

24. The electronic device of claim 20, wherein the color extractor acquires an average color of pixels included in the divided region.

25. The electronic device of claim 20, wherein the color extractor is configured to acquire any one of colors included in a predetermined color composition table based on a similarity between an average color of pixels included in the divided region and a color included in the predetermined color composition table.

26. The electronic device of claim 20, wherein the content is a plurality of contents, and the color palette generator comprises:
a counter configured to store a number of times each color information has been acquired from images included in the plurality of contents.

27. The electronic device of claim 20, wherein the color palette generator further comprises a color determiner configured to determine a color to be included in the color palette based on the number of times the color information has been acquired.

28. The electronic device of claim 20, wherein the content is reproduced or generated in the electronic device.

29. The electronic device of claim 28, further comprising a database storage configured to store information related to the content reproduced or generated in the electronic device according to a point of time when the content is reproduced or generated in the electronic device.

30. The electronic device of claim 29, wherein the image acquirer is configured to select the content from the database storage according to the point of time when the content is reproduced or generated in the electronic device, and acquires the image included in the selected content.

31. The electronic device of claim 20, further comprising an image generator configured to select an image to be displayed from among images stored in the electronic device based on brightness, chroma and color of the color information included in the color palette, and change a color of the selected image by using the color palette generated by color palette generator.
